(19) United States
(12) Patent Application Publication
(10) Pub. No.: US 2025/0095431 A1
(43) Pub. Date: Mar. 20, 2025

(54) SYSTEM AND METHOD FOR REMOTELY VENDING ITEMS

(71) Applicant: Jay's Tree Care, LLC, Royalton, MN (US)

(72) Inventor: Jason H. Leibold, Royalton, MN (US)

(21) Appl. No.: 18/887,350

(22) Filed: Sep. 17, 2024

Related U.S. Application Data
(60) Provisional application No. 63/583,410, filed on Sep. 18, 2023.

(51) Int. Cl. G07F 17/00; G07C 9/00

(52) U.S. Cl. CPC G07F 17/0042; G07C 9/00896

(57) ABSTRACT

A container for vending firewood includes a first compartment having a first door secured by a first latch and a first lock and a second compartment having a second door secured by a second latch and a second lock. The first compartment is larger than the second compartment. A method vending firewood includes receiving a request from a user to purchase firewood; receiving payment from a user for the firewood; and providing access to the firewood.

### CROSS-REFERENCE TO RELATED APPLICATIONS

This application claims the benefit of priority to U.S. Provisional Application No. 63/583,410, filed Sep. 18, 2023. The aforementioned application is incorporated by reference herein in its entirety.

### FIELD OF THE DISCLOSURE

The present solution relates to vending items to customers in remote locations using a multi-compartment container-based vending system.

### BACKGROUND

Currently, firewood is typically sold in certain retail environments and through firewood delivery services. In some instances or locations, individuals may not have the ability to conveniently get firewood at the time desired. For example, people who go camping may not have firewood available to them. Many state regulations limit the transport of firewood, and many campsites do not offer firewood for sale. Campers may also run out of firewood while camping and distances may be too long to purchase additional firewood. In addition, there may be locations or times of the day where no firewood is sold. Therefore, improvements are desirable.

### SUMMARY

The present invention provides a solution to the problem of not having firewood available for sale at remote campsites by providing a system by which sellers of firewood can remotely vend firewood.

In one aspect of the present invention, a container for vending firewood includes a first compartment having a first door secured by a first latch and a first lock and a second compartment having a second door secured by a second latch and a second lock. The first compartment is larger than the second compartment.

In another aspect of the present invention, a method of vending firewood including: receiving a request from a user to purchase firewood; receiving payment from a user for the firewood; and providing access to the firewood.

### BRIEF DESCRIPTION OF THE DRAWINGS

FIG. 1 is a diagram illustrating a vending container, according to one example embodiment of the present disclosure.

FIG. 2 is a flow diagram of a method of remotely vending firewood, according to one example embodiment of the present disclosure.

FIG. 3 is a flow diagram of a method of remotely vending firewood, according to another example embodiment of the present disclosure.

FIG. 4 is a diagram illustrating a vending container, according to another example embodiment of the present disclosure.

### DETAILED DESCRIPTION

In general, the present invention provides a container for vending firewood or other items. The container is divided into subsections or compartments that can be lockable. Each subsection can be of different sizes and configurations. Each subsection can be independently unlocked and opened, providing access to firewood within the subsection. The purchaser can be provided with access to the subsection for a fee such that the user can remove the firewood for the purchaser's use. In other words, a system to vend firewood to end users is provided. The system can be as simple as a container with a mechanical door with a mechanical lock. A user would call a phone number, provide payment and receive instructions to unlock the mechanical lock to retrieve the contents. The system can also be more elaborate. The container can be connected to a network with each section having an electronic lock and display. The display can be used to display a price for the firewood. An app on a mobile phone could be used to accept payment and unlock the electronic lock. A feedback loop could be used to indicate whether the subsection is full or empty. Dynamic pricing can be used such that as the subsections become empty, the price of firewood per remaining subsection goes up and the display changes accordingly. Of course, the container and subsections could also be used to vend other items. Any suitable item could be vended.

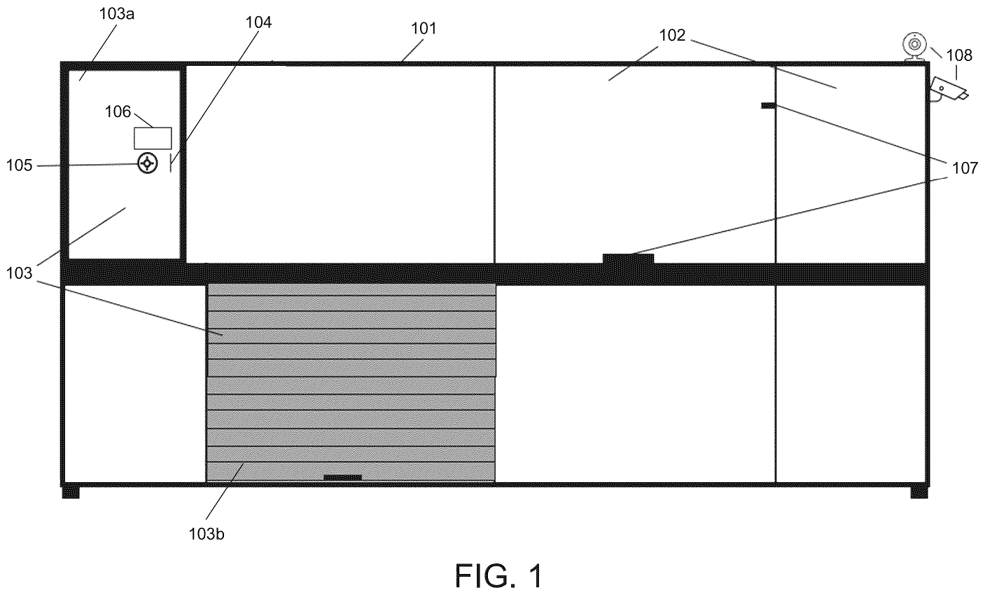

Referring to FIG. 1, a container 101 is generally illustrated. Preferably, a shipping container is used. Standard shipping containers have a width of 8′ feet and heights of either 8′-6″ or 9′-6″. Standard shipping containers have lengths of 9′-9.75″, 19′-10.5″, 40′, 45′ or 60′. Of course, any size container could be used. And, any suitable container could be used beyond standard shipping containers. The container 101 is subdivided into compartments 102 of varying sizes. The compartments 102 can hold items, such as firewood, for dispensing with or without the need for a human vendor present at the time of sale. Each compartment 102 includes a closing apparatus 103, such as a door. In FIG. 1, two types of doors 103 are shown including a swinging door 103a and an overhead door 103b. A smaller compartment 102 may have a swinging door 103a and a larger compartment 102 may have an overhead door 103b. Any suitable door or closing apparatus might be used. Each door 103 is held closed by a latch 104. The latch 104 can be any known latch. Example latches are a door knob or press fitting.

Preferably, the door 103 is secured by a locking mechanism 105. The locking mechanism 105 can be a simple mechanical lock such as a padlock, combination lock or key lock or can be an electronic lock. The compartment 102 can also have a display 106 for displaying information, such as a price. The display can be an electronic display as well. The container 101 can also have one or more sensors 107 in each compartment 102 to determine the fill state of each respective compartment 102. The sensors 107 can simply indicate whether the compartment is full or empty or indicate a level of fill. The container 101 could also include a security system 108. The security system 108 could include cameras for remotely viewing the container. The risk of leaving a vending system unattended at a campsite for an extended period can be mitigated by the presence of the one or more cameras.

In one embodiment, each compartment 102 of the shipping container 101 has a padlock attached with a unique combination required to open the padlock. The owner or operator of the system for remotely vending firewood can rotate or replace each padlock when reloading firewood into the respective compartments to ensure that prior purchasers are unable to reopen the same compartment after it has been refilled.

In some embodiments, the firewood vending system may include a computer-implemented system to allow for automated sales, feedback on remaining stock, dynamic price setting, security and other features.

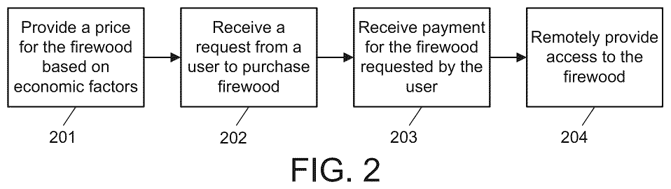

A method of remotely vending firewood is shown in FIG. 2. In this example embodiment, at 201 a price is provided for the firewood based on economic factors, which may include the amount of firewood left in the compartment (such as a compartment 102 of FIG. 1), the total amount of firewood left in the container (such as the container 101 of FIG. 1) and the current or predicted demand for firewood (for example the 4^{th} of July weekend might command a higher price for firewood). At 202, a request is received from a user to purchase firewood. At 203 payment or confirmation of payment is received for the firewood. At 204, access is provided remotely to the user to access to the firewood. In this embodiment, the price for firewood in each compartment is already displayed when a user first arrives. In other embodiments, the price may be displayed at a later point. In summary, a user arrives at the container and views the prices for the firewood in different sized compartments. The user selects the compartment from which he/she wishes to purchase firewood. The user purchases the firewood for the price shown and is provided access to the compartment in order to retrieve the firewood. The user could call a phone number to provide payment and in return receive a code to a combination lock. In another example, the user could use an app to provide payment and receive a code to unlock a combination lock or an electronic lock. The display could be electronic with a price displayed. The electronic lock could be remotely unlocked after payment is received.

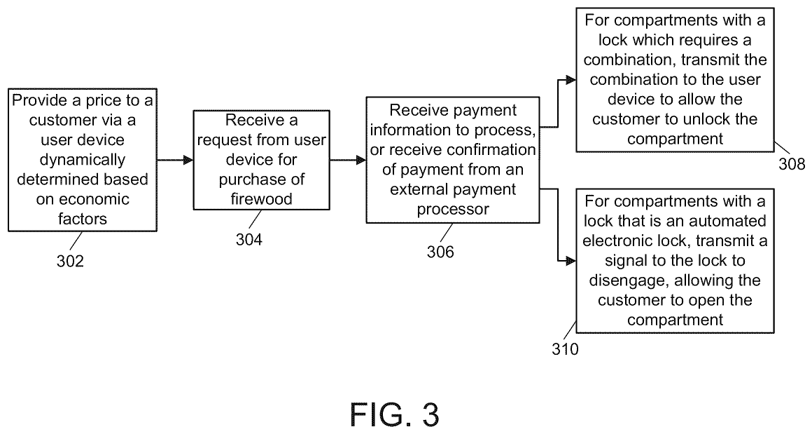

FIG. 3 is a flow diagram that depicts another example embodiment of a method of remotely vending firewood. In this embodiment, a server is in communication with a user device via an application. At 302, a price is provided to a customer via the user device through the application based on dynamically determined economic factors. At 304, a request is received from the user device to purchase the firewood and at 306 payment information is received to process or confirmation of payment form an external payment processor is received. Flow either branches to 308 for a mechanical lock or to 310 for an electronic lock. At 308, the combination to the mechanical lock is transmitted to the user device for the customer to unlock the lock and retrieve the firewood. At 310, a signal is transmitted to an electronic lock to disengage, allowing the customer to gain access to the compartment to retrieve the firewood. It is also possible to transmit the code to the electronic lock to the user for the user to unlock the electronic lock.

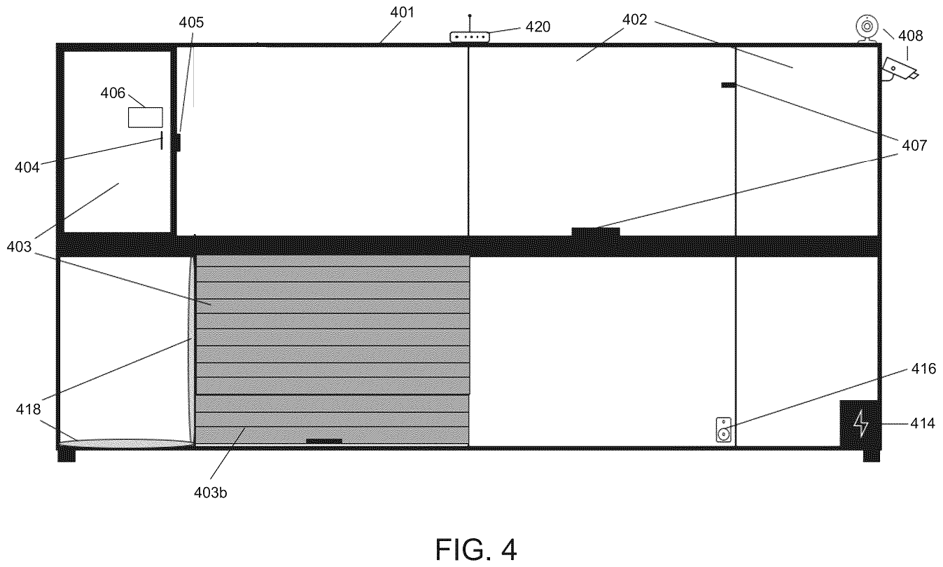

FIG. 4 depicts another example embodiment of a system for remotely vending firewood. The shipping container 401 is divided into multiple compartments 402. Each compartment includes a closing apparatus 403. Compartments in this embodiment contain a latch 404 adapted to engage the closing apparatus 403 and an electronic locking mechanism 405. In some embodiments, each compartment 402 contains a sensor, coupled to the latch on the compartment door, detecting and relaying information about whether the compartment door is open or closed back to the operator.

The electronic locking mechanism is coupled to a battery 414. The embodiment includes one or more cameras 408, which may have a separate power source or may be coupled to the battery 414. The embodiment additionally contains a pest-repellant system 416, which may be powered or unpowered, and may have a separate power source or may be coupled to the battery 414. The embodiment in FIG. 4 includes a seal 418 in compartments to help prevent pests and insulate against weather conditions.

The example embodiment includes a hub 420, or transmitter/receiver, which may have a separate power source or may be coupled to the battery 414, and acts as the central point of communication, for example to a remote server or to the internet. The hub 420 may include a server, a data storage device, and a network and could be a stand-alone system at the container. Embodiments could also include a separate backend server.

In some embodiments, the hub 420 can be used to transmit the price to one or more displays 406 associated with compartments, used to unlock electronic locks and to transmit video from the cameras 408.

In some embodiments, each compartment 402 has an electronic lock 405 running off a battery 414 located on-site. The owner or operator of the system for remotely vending firewood can remotely program or reprogram the code needed to disengage the electronic lock 405 for the respective compartment 402 within the vending system. In other embodiments, a backend system automatically disengages the electronic lock 405 without the need for an end user to input a code. The battery 414 can be recharged. The battery 414 could also be replaced by a standard electric cord if power is available near-by. The container 401 could be equipped with both a battery and standard power.

In one embodiment, the one or more user devices that communicate with the hub 420 are referred to broadly and are intended to encompass a suitable processor-based device such as a desktop computer, a laptop computer, a personal digital assistant (PDA) or tablet computer, a smartphone, or other mobile communication device having access to the network. In a further embodiment, the one or more user devices may access the Internet or other wide area or local area network to access a web application or web service hosted by the server and may provide a user interface for enabling a user to enter or receive information.

The network may facilitate communications of data between the server and hub 420. The network may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

The components of the hub 420 and/or server may be any suitable processor-based device including, without limitation, IoT devices, tablet computers, smartphones, computer game consoles, and multi-processor servers. Persons of ordinary skill in the art may utilize any number of suitable structures capable of executing logical operations according to the described embodiments. For example, the hub and/or server may be virtualized for access by multiple users and/or applications.

If implemented in firmware and/or software, the functions described above may be stored as one or more instructions or code on a computer-readable medium. Examples include non-volatile computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, solid-state storage, flash memory, magnetic disk storage or other magnetic storage devices, or any other medium that can be used to store desired program code in the form of instructions or data structures and that can be accessed by a computer. Disk storage includes compact discs (CD), laser discs, optical discs, digital versatile discs (DVD), floppy disks, and Blu-ray discs. Generally, disks reproduce data magnetically, and discs reproduce data optically. Generally, solid-state storage uses electronic circuits to reproduce data, including flash memory. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

1. A container for vending firewood comprising:
a first compartment having a first door secured by a first latch and a first lock;
a second compartment having a second door secured by a second latch and a second lock;
wherein the first compartment is larger than the second compartment.

2. The container of claim 1, wherein the first lock is a combination padlock.

3. The container of claim 2, wherein the first compartment has a first display.

4. The container of claim 3, wherein the first compartment includes a seal.

5. The container of claim 1, wherein the first lock is an electronic lock.

6. The container of claim 5, wherein the first compartment has a first display and the second compartment as a second display.

7. The container of claim 6, wherein the first display is an electronic display.

8. The container of claim 7, wherein the first display is connected to a server such that a price can be set by the server and displayed by the first display.

9. The container of claim 8, wherein the electronic lock can be unlocked by the server.

10. The container of claim 9, wherein the first compartment includes a first sensor detecting if the first compartment is full or empty.

11. The container of claim 10, wherein the server communicates with a user device to receive payment and provide access to the electronic lock.

12. The container of claim 10, wherein the server changes the price of firewood on the second display when the first compartment is detected as empty by the first sensor.

13. The container of claim 1, further comprising a security system.

14. A method of vending firewood including:
receiving a request from a user to purchase firewood;
receiving payment from a user for the firewood; and
providing access to the firewood.

15. The method of claim 14, further comprising displaying a price for the firewood on an electronic display.

16. The method of claim 15, wherein providing access to the firewood includes sending a code to the user to unlock a lock to a compartment containing the firewood.

17. The method of claim 15, wherein providing access to the firewood includes remotely unlocking an electronic lock to a compartment containing the firewood.

18. The method of claim 15, further comprising setting a price for the firewood based on economic factors including how much firewood is remaining in a container.

19. The method of claim 18, further comprising dynamically setting the price as the economic factors change.

20. The method of claim 19, wherein receiving a request and receiving a payment include through a mobile user device.
